(19) United States
(12) Patent Application Publication
(10) Pub. No.: US 2008/0198370 A1
(43) Pub. Date: Aug. 21, 2008

(54) Method and Device For Measuring the Concentricity of an Optical Fiber Core

(75) Inventor: Loic Cherel, Annecy (FR)

Correspondence Address: YOUNG & THOMPSON, 209 Madison Street, Suite 500, ALEXANDRIA, VA, 22314, US

(73) Assignee: DATA PIXEL, CRAN-GEVRIER (FR)

(21) Appl. No.: 11/997,408

(22) PCT Filed: Jul. 11, 2006
(86) PCT No.: PCT/FR2006/001683

§ 371 Date: Jan. 31, 2008

(30) Foreign Application Priority Data
Aug. 5, 2005 (FR) 0508388

(51) Int. Cl. G01M 11/00

(52) U.S. Cl. 356/73.1

(57) ABSTRACT

Device for measuring the concentricity of the core 21 of an optical fiber 19 relative to a reference axis 22, comprising a means for determining the position of the intersection of the reference axis 22 with an optical face 23 on the end of the optical fiber 19, a means 17 for injecting light into the core 21 of the optical fiber 19, an objective 30 and a means 4 for observing, in a plane 5 conjugate with the optical face 23, the light emitted by the core 21 of the optical fiber 19, characterized in that the objective 30 has a numerical aperture sin β smaller than the numerical aperture sin α of the optical fiber to be measured.

The invention relates to the field of devices and methods for measuring the concentricity of the core of an optical fiber relative to a reference axis. The invention relates in particular to measuring the concentricity of the core of the fiber of an optical connector, the reference axis of which is defined by the outside diameter of the ferrule of the optical connector.

In this field, the standard IEC 61300-3-25 describes a method of determining the concentricity of the axis of the core of an optical fiber with the outside diameter of the ferrule of an optical connector. In this method, a light source illuminates the core of the optical fiber at one end of the fiber. The ferrule, in which the optical fiber is fixed, is placed in a Vee or a centering mechanism. The optical face is positioned facing a microscope. The image of the core of the optical fiber is formed on a matrix sensor of a video camera. The optical fiber is pivoted about the axis of the ferrule and the successive positions of the center of the core are calculated in order to deduce therefrom the concentricity of the core of the fiber relative to the pivot axis.

Many instruments use this method for measuring polished optical connectors with a domed shape, a plane of tangency at the core of the fiber of which is approximately perpendicular to the axis of the ferrule of the optical connector. For simplification, these connectors are called straight polished connectors. There are also connectors the optical face of which is polished so as to be domed with a plane of tangency at the core of the fiber that is inclined at an angle of 8° to the normal to the axis of the ferrule. For simplification, these connectors are called angled polished connectors. The light beam emerging from the angled polished optical face is inclined to the axis of the ferrule. As will be explained in detail in the description, this introduces a lateral offset of the image of the core. The order of magnitude of this lateral offset is greater than the lateral offset due to the concentricity defects that it is desired to measure, so that the standardized method is not applicable for angled polished optical connectors.

This drawback also arises when measuring straight polished connectors. The apex of the domed polishing face is slightly offset laterally relative to the center of the core. The lateral polishing defect tolerated by the standards is 50 μm. This results in a tolerance on the angle of the optical face at the core of around 0.6 degrees to the normal to the axis of the ferrule for a domed polishing face radius of 5 mm.

The concentricity measurement is mainly necessary for singlemode fibers that have a numerical aperture of 0.11 and a fiber core diameter of about 10 μm. The concentricity that it is desired to measure is a diameter of around 0 to 2 μm. The effect of the lateral offset of the apex of the domed polishing face introduces an inclination of the beam emitted by the optical connector when the optical face is in air. This increases the uncertainty, to the detriment of the result of the standardized concentricity measurement method.

The invention proposes a device and a method for measuring the concentricity of the core of an optical fiber face relative to a reference axis that remedies the above problems and in particular overcomes the effect of the angle of the optical face at the core.

According to one embodiment, the device for measuring the concentricity of the core of an optical fiber relative to a reference axis, comprises a means for determining the position of the intersection of the reference axis with an optical face on the end of the optical fiber, a means for injecting light into the core of the optical fiber, an objective and a means for observing, in a plane conjugate with the optical face, the light emitted by the core of the optical fiber. The objective has a numerical aperture smaller than the numerical aperture of the fiber to be measured.

In such a device, the objective transmits only that part of the light beam emitted by the fiber which lies within the acceptance cone defined by the numerical aperture of the objective. This amounts to the peripheral propagation modes being filtered out and the central propagation modes being let through. The light spot received by the observation means is centered on the optical axis passing through the center of the core of the measured fiber and the optical center of the objective. This makes it possible to factor out the possible asymmetry in the beam emitted by the optical core and therefore in the possible angle of the optical face at the core.

Advantageously, the numerical aperture of the objective is less than 0.11, or preferably less than 0.08 or in particular less than 0.06. Furthermore, and independently, the numerical aperture of the objective is advantageously greater than 0.01, or preferably greater than 0.02 or in particular greater than 0.03.

Advantageously, the observation means is a digital camera sensitive to the light of the injection means.

According to another embodiment, the device intended for measuring the concentricity of the core of the fiber of an optical connector, the reference axis of which is defined by an outside diameter of a ferrule of the optical connector, comprises a means for rotating the optical face relative to the outside diameter of the ferrule, a means for calculating the position of the center of the optical core for each of the positions of the optical face, and a means for calculating the diameter of the circle passing through said positions of the center of the optical core.

Advantageously, when the optical axis of the objective is approximately aligned with the reference axis, the numerical aperture of the objective is obtained by a diaphragm positioned in the image focal plane of the objective.

According to another embodiment, the numerical aperture of the objective is obtained by a pupil positioned in the transverse entry plane of the objective.

According to one mode of implementation, the method for measuring the concentricity of the core of an optical fiber relative to a reference axis includes a step in which light is injected into the core of the optical fiber, the light emitted by the core is observed by means of the objective and the position of the intersection of the reference axis with the optical face is determined, and the propagation modes that are peripheral to the central axis of the objective are filtered out.

Advantageously, the method uses an objective the numerical aperture of which is smaller than the numerical aperture of the optical fiber.

According to another mode of implementing the invention, the method is such that the determination of the position of the intersection of the reference axis with the optical face includes a first step in which the reference axis of the fiber to be measured is positioned relative to the objective and a first position of the center of the light spot emitted by the fiber is measured in an image plane of the objective and then, in a second and a third step, the fiber is pivoted in two other angular positions about the reference axis, a second position and a third position of the center of the emitted light spot are measured and the center of the circle passing through said three positions is calculated.

According to another mode of implementing the invention, the method, intended for an optical connector the reference axis of which is defined by a reference diameter relative to which an optical face is fixed, includes a prior step in which the position of the intersection of the reference axis with the optical face is determined by means of a first fiber, said position is stored and then the reference diameter of the optical fiber to be measured is repositioned so that the reference axis of the fiber to be measured is in the identical position to the reference axis of the first fiber.

According to yet another mode of implementing the invention, the method, intended for an optical connector, the reference axis of which is defined by a diameter relative to which an optical face is fixed, includes a step in which the position of the intersection of the reference axis with the optical face is determined by illuminating the diameter and by calculating the position of the center of said diameter.

Other features and advantages of the invention will become apparent on reading the detailed description of an embodiment given by way of nonlimiting example and illustrated by the appended drawings in which:

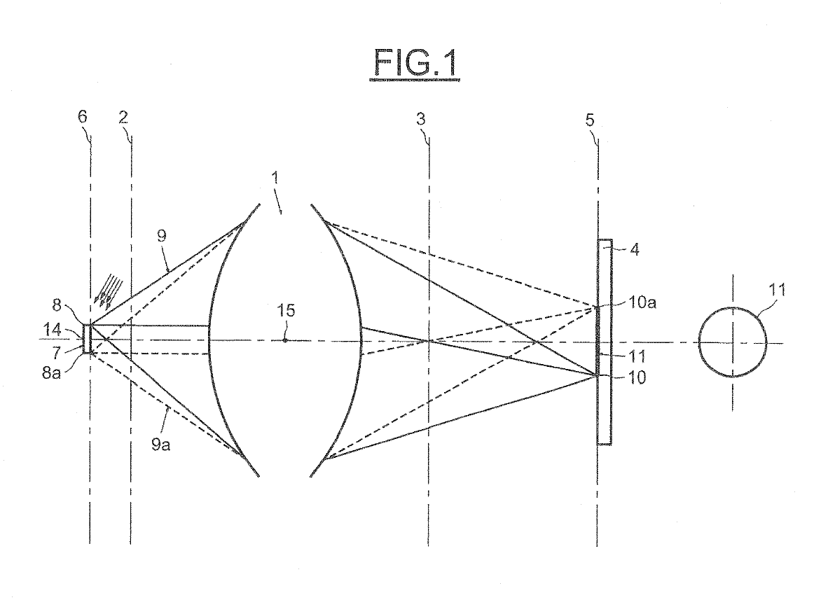

FIG. 1 is an illustration of the image obtained by an objective of an object emitting scattered light;

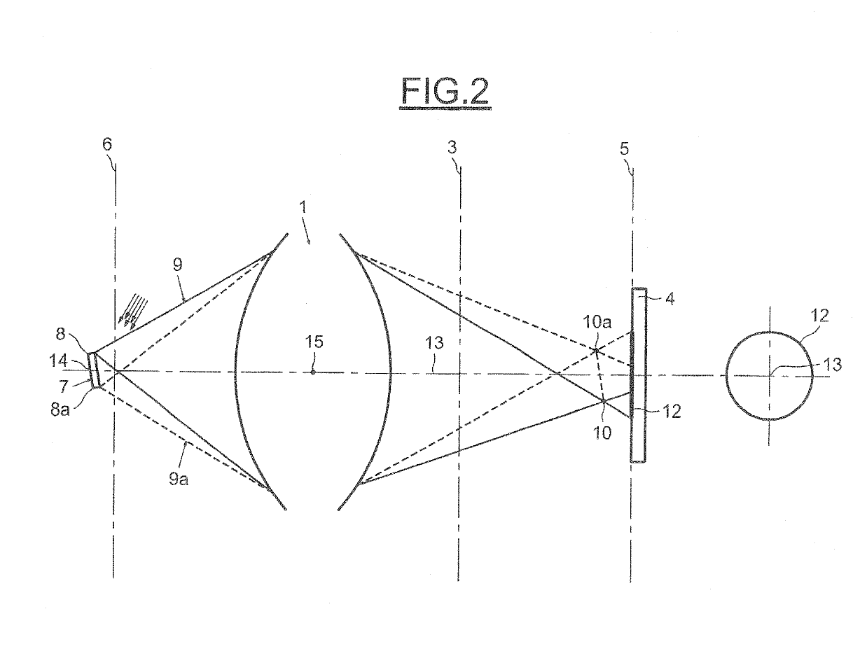

FIG. 2 is an illustration of the effect of a longitudinal offset of the object on the image obtained in FIG. 1;

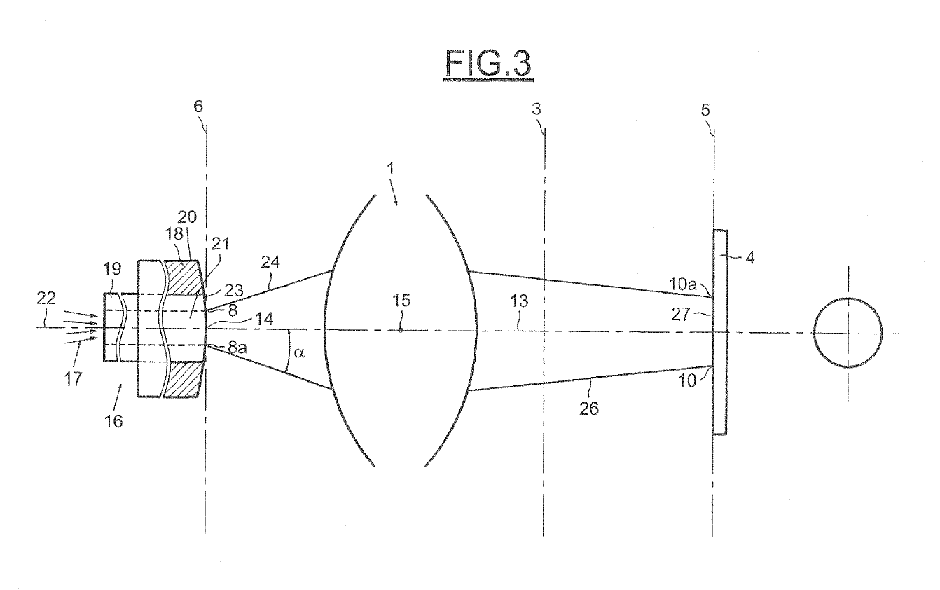

FIG. 3 is an illustration of the image obtained by an objective of an optical fiber core;

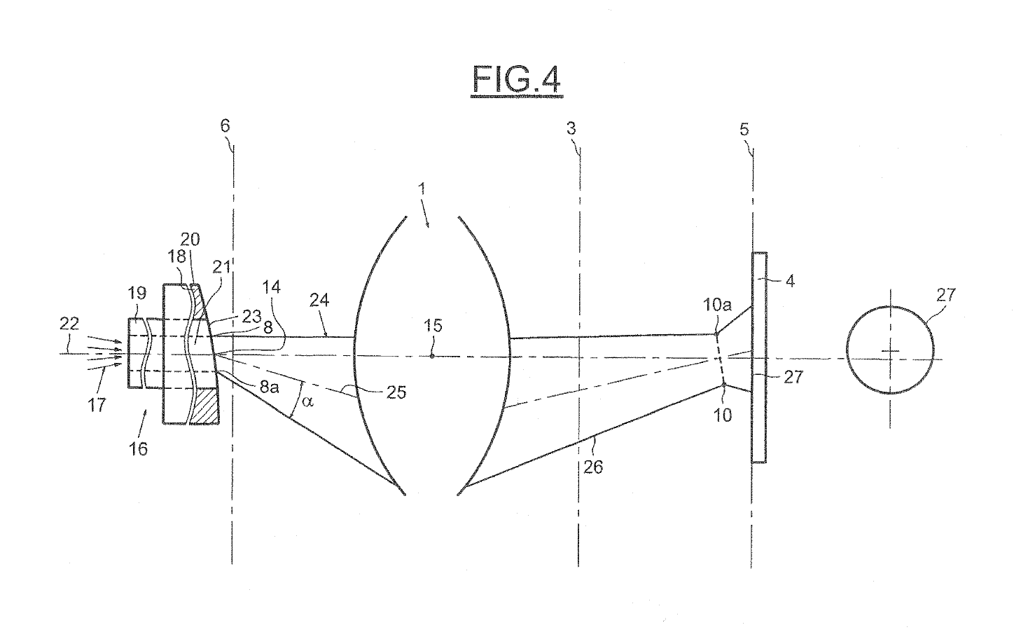

FIG. 4 is an illustration of the effect of a longitudinal offset of an angled polished optical face on the image obtained in FIG. 3;

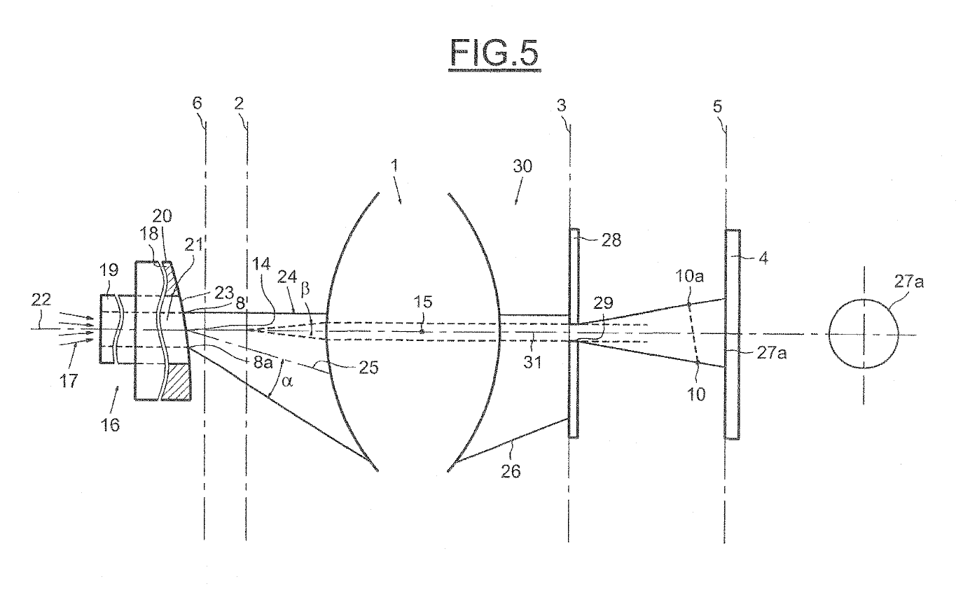

FIG. 5 is an illustration of the filtering step according to the invention; and

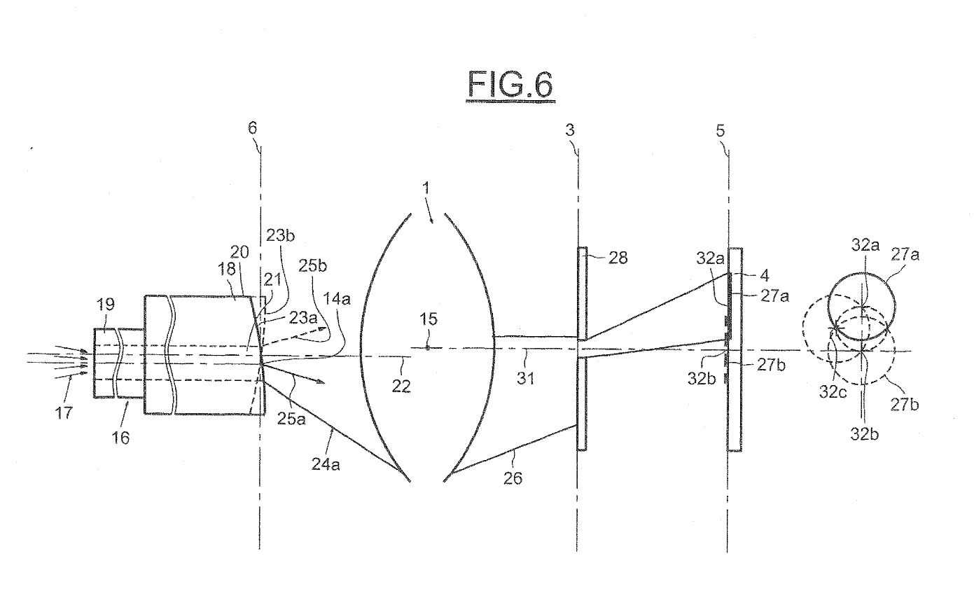

FIG. 6 is an illustration of one mode of implementing the method and an embodiment of the measurement device according to the invention, and especially one for implementing the step of determining the position of the intersection of the reference axis with the optical face.

As illustrated in FIG. 1, a lens 1 has an object focal plane 2 and an image focal plane 3. A video camera possesses a matrix sensor 4 lying in a plane 5 parallel to the focal planes 2, 3 and located to the rear of the image focal plane 3. A plane 6 is the conjugate plane of the plane 5 in the object space. When an inert object 7 is positioned in the plane 6 and illuminated by an external light source, each point of the object 7 scatters light in all directions. A top point 8 of the object 7 emits a beam 9 of light rays, indicated by the solid lines, which beam passes through the objective and converges on a point 10. Likewise, a bottom point 8a of the object 7 emits a light beam 9a, indicated by the dotted lines, which beam converges on a point 10a. Since the object 7 lies in the plane 6, the image points 10 and 10a lie in the plane 5. The matrix sensor 4 receives an image 11 of the object 7. This image is sharp and has a diameter corresponding to the object 7 increased by the magnification M of the lens 1.

If the object 7 is moved back to the rear of the plane 6 and inclined, as illustrated in FIG. 2, the end points 8 and 8a of the object 7 emit beams that converge on points 10 and 10a positioned in front of the plane 5. The image 12 received by the matrix sensor 4 is blurred and has a larger diameter than that of the sharp image 11. Whatever the inclination and longitudinal offset of the object 7, the image 12 remains centered on an optical axis 13 connecting the center 14 of the object 7 and the optical center 15 of the lens 1.

The configurations similar to FIGS. 1 and 2 in which the object 7 is replaced by an optical connector 16 will now be described with the aid of FIGS. 3 and 4, light being injected into said optical connector by a means 17 (not shown). The optical connector 16 includes a ferrule 18, generally made of zirconia or a metal, and an optical fiber 19, generally made of silica fixed in a bore of the ferrule 18. The ferrule 18 has an outside diameter 20, generally 1.25 mm or 2.5 mm for telecommunication applications. This diameter is very precise and has a cylindricity tolerance of generally less than 1 μm, so that this diameter 20 serves as reference to the optical connector 16. The optical fiber 19 has an optical core 21 of higher optical index than the index of the periphery of the fiber, so as to guide the light energy. The energy injected at one of the ends of the optical fiber 19 by the means 17 leaves the other end of the optical fiber 19 via an optical face 23. The axis of the optical core 21 of the fiber 19 is virtually parallel to the reference axis 22 of the outside diameter 20. When the optical face 23 is in air, the light energy continues its propagation via a beam 24 emitted along a cone of propagation. The numerical aperture (sin α) of the optical fiber 19 is by definition the sine of the half-angle α of the cone of propagation and depends on the optogeometric characteristics of the fiber.

Unlike the beams 9 and 9a emitted by the inert object 7, the beam emitted by the optical core 21 has a preferential direction that depends on the angle that the optical face 23 makes with the reference axis 22 of the optical connector 16. When the optical face 23 is approximately perpendicular to the reference axis 22, the beam 24 is emitted in the extension of the reference axis 22, as illustrated in FIG. 3. When the optical face is a polished face angled to the reference axis 22, the emitted beam 24 has a conical shape about a central ray 25 inclined to the reference axis 22, as illustrated in FIG. 4.

The light energy passes through the lens 1 and is concentrated as a transmitted beam 26. If the object 7 has the same dimensions and positions as the core 21 of the optical face 23, then the transmitted beam 26 converges on the points 10 and 10a described in FIGS. 1 and 2. In FIG. 3, the optical face 23 is perpendicular to the reference axis 22 and the matrix sensor 4 receives a light spot 27 in alignment with the optical axis 13 passing through the center 14 of the optical core 21 and the optical center 15 of the lens 1. In FIG. 4, the optical face 23 makes an angle, the light spot 27, detected by the matrix sensor 4, is laterally offset from the optical axis 13. The value of this lateral offset depends on the polishing face angle, on the longitudinal offset of the optical face 23 relative to the plane 6 and on the optical characteristics of the fiber 19. In the case of an angled polished silica singlemode fiber, the inclination of the central ray 25 is 3.8° to the reference axis 22. The cone angle α of the emitted beam 24 is +6° about the central ray 25. The concentricity that it is desired to measure is a diameter of around 2 μm. The longitudinal offset of the optical face 23 causing a lateral offset of the light spot 27 of about 2 μm is only ±15 μm. It will be understood that the standardized method, requiring a physical rotation of the optical connector 16, does not cover angled polished optical connectors.

As illustrated in FIG. 5, the lens 1 is equipped with a diaphragm 28 positioned in the image focal plane 3 of the lens 1. The diaphragm 28 and the lens 1 form an objective 30 of axis 31. The numerical aperture (sin β) of the objective 30 is by definition the sine of the half-angle β of the light cone that would emerge from a point in the object focal plane 2 before being converted by the lens 1 into a parallel beam bounded by the diaphragm 28. The numerical aperture indicates the maximum inclination of the beams that the objective 30 is capable of accommodating. This numerical aperture is the direct consequence of an aperture diameter 29 of the diaphragm 28 and of the optogeometric characteristics of the lens 1. The axis 31 of the objective 30 and the matrix sensor 4 are approximately aligned with the reference axis 22 of the optical connector 16. The emitted beam 24 is asymmetric so that only a small lateral portion of this beam is transmitted and constitutes a light spot 27a received by the matrix sensor 4.

In the case of a singlemode fiber, an optical magnification system 10 of 0.25 numerical aperture is for example used. When this optical system is combined with the diaphragm 28 of 400 μm aperture diameter 29 lying in the image focal plane 3, an objective 30 having a numerical aperture of around 0.05 is obtained. The effect of the diaphragm 28 may be described in an imaged manner by pointing out that the presence of the diaphragm 28 does not change the focal points of the beams, so that the transmitted beam 26 is aimed at the points 10 and 10a of FIG. 4. It will therefore be understood that the light spot 27a is centered on the optical axis 31, that is to say the effect of the lateral offset of the spot 27 visible in FIG. 4, which offset is due to the asymmetry of the beam 24, has been eliminated.

Since the diameter of the fiber core 21 is of an order of magnitude close to the wavelength of the light, it is preferable to describe the effect of the diaphragm 28 in terms of energy propagation. If there is an imaginary screen in the image focal plane 3, an image would be obtained having the shape of the optical Fourier transform of the shape of the core 21 of the fiber. Since the core 21 is of circular shape, the Fourier transform of this shape is a series of concentric rings. The effect of the diaphragm 28 is to spatially filter the propagation modes, letting through the lower-order modes corresponding to the central axis 31 of the objective 30 while blocking the higher-order peripheral modes. The light spot 27a no longer benefits from the superposition of the peripheral higher-order modes. These peripheral higher-order modes contribute to the sharpness of the image 27, but are also responsible for its lateral offset. The diaphragm 28 thus positioned is a low-pass filter that makes it possible to obtain a lightspot 27a that is less sharp than the spot 27 obtained in the configurations described in FIGS. 3 and 4, but this spot 27a is centered on the optical axis 31 despite the longitudinal offset of the optical face 23 relative to the plane 6 and despite the angular deviation of the central beam 25 from the emitted beam 24.

One way of carrying out the step of determining the position of the intersection of the reference axis 22 with the optical face 23 will now be described with the aid of FIG. 6. Thanks to the filtering step described in FIG. 5, the device allows the concentricity of the core of the fiber relative to the reference axis 22 to be measured.

In FIG. 6, the lack of concentricity of the core 21 of the optical fiber 19 relative to the reference axis 22 has been accentuated. The alignment of the axis 31 of the objective 30 with the reference axis 22 of the optical connector 16 allows the peripheral modes to be correctly filtered out. However, the two axes 22 and 31 may be offset by a few microns, as illustrated in FIG. 6, without affecting the precision of the measurement. In a first position of the optical connector 16 illustrated by the solid lines, the light introduced by the injection means 17 leaves from an optical face 23a in the direction of a central ray 25a. The objective 30 filters out the peripheral modes of the emitted beam 24a, and a light spot 27a is received by the matrix sensor 4. A computer is used to determine the position of the center 32a of the light spot 27a. The center 14a of the core 21, the optical center 15 of the objective 30 and the center 32a of the light spot 27a are in alignment.

Next, the optical connector 16 is pivoted about the reference axis 22. The means of pivoting the connector 16 about the reference axis 22 may be achieved by a device pressing the outside diameter 20 on a Vee or on a centering mechanism, such as a resilient ring. The Vee or the resilient ring are fixed relative to the objective 30.

The second position of the optical connector 16 corresponds to it being pivoted through any angle, for example 180°, as illustrated by the dotted lines in FIG. 6. The light introduced by the injection means 17 leaves from an optical face 23b in the direction of a central ray 25b and rejoins the matrix sensor 4 in the form of a light spot 27b. The computer determines the position of the center 32b of the light spot 27b. The center 32b, the optical center 15 of the objective 30 and the center of the core 21 in this second position of the connector 16 are in alignment.

The connector 16 is again pivoted about the reference axis 22. This makes it possible to determine the center 32c of the light spot corresponding to the center 14 of the core 21 of the connector 16 in this third position. A computer determines the diameter of the circle passing through the three points 32a, 32b, 32c. By dividing this diameter by the magnification M of the objective 30, the concentricity of the core 21 relative to the reference axis 22 is obtained. The center of this circle is the image of the point of intersection of the reference axis 22 with the optical face. The means for pivoting the connector 16 relative to the reference axis 22 of the ferrule 18, connected to the computer, constitutes a means for determining the position of the intersection of the reference axis 22 with the optical face 23.

The device and the method of the invention make it possible to factor out the angle of the optical face 23 at the core and/or a longitudinal offset of the optical face 23 relative to the plane 6 conjugate with the plane 5 in which the light spot 27 is observed.

The filtering-out of the peripheral modes by the objective 30 starts as soon as the numerical aperture of the objective 30 is smaller than the numerical aperture of the optical fiber 19.

Since the concentricity measurements are particularly necessary for telecommunication applications in the case of silica singlemode fibers, the core diameter of which is 10 μm and the numerical aperture of which is 0.11, a device equipped with an objective 30 having a numerical aperture of less than 0.11 allows the method of the invention to be implemented for singlemode optical fibers.

Preferably, the device is equipped with an objective 30 having a numerical aperture of less than 0.08. This makes it possible to eliminate the contribution of the lateral offset of the apex of the non-angled domed polishing face of optical connectors provided with a singlemode fiber to the uncertainty in the concentricity measurement.

Even more preferably, the device is equipped with an objective 30 having a numerical aperture of less than 0.06. This makes it possible to measure angled polished connectors provided with a singlemode fiber.

If an objective having a numerical aperture of 0.05 gives a certain level of filtering for optical fibers of 10 μm core diameter, the same level of filtering could be achieved for fibers with a 3 to 5 μm core diameter by an objective having a numerical aperture close to 0.1, and thus allowing angled polished optical connectors to be measured.

For optical fibers having a numerical aperture greater than 0.11, for example for fibers made of a material other than silica, the invention may be implemented by a device in which the objective has a numerical aperture of greater than 0.11 but less than the numerical aperture of the fiber to be measured.

Moreover, the smaller the numerical aperture of the objective 30 the less energy is transmitted by the objective 30 to the matrix sensor 4 of the camera. Preferably, the device is equipped with an objective 30 having a numerical aperture greater than 0.01 in order to avoid having to employ light injection sources 17 that are too powerful with the risk of degrading the optical connector to be measured.

Even more preferably, the numerical aperture of the objective is greater than 0.02, and a light injection means 17 and a matrix sensor that are readily available are used. Advantageously, the device is equipped with an objective having a numerical aperture of greater than 0.03. This makes it possible to obtain a light spot 27 transmitted by the objective 30, the contours of which are sufficiently pronounced for the center 32a, 32b, 32c of the light spot 27 to be sufficiently detectable.

The IEC 61300-3-25 standard was published in March 1997. Angled polished optical connectors existed well before the drafting of this standard. The fact of reducing the numerical aperture of the objective goes counter to the preconceptions of optics experts. This is because the distance to be measured between the various positions of the center 14 of the core 31 of the optical fiber 19 during the pivoting is of the order of one micron, and therefore close to the wavelength. The natural tendency of an optics expert is to maximize the numerical aperture so as to increase the separating power of the objective 30. The fact of reducing the numerical aperture of the objective 30 degrades the sharpness of the image 27a of the core 31. It is a particularly surprising effect that the fact of filtering out the higher-order peripheral modes of the objective 30 makes it possible to factor out the angle of the optical face 23.

Other modes of implementing the measurement method will now be described. In a second mode of implementation, the intersection of the reference axis 22 with the optical face 23 may be determined, not by pivoting as in the first method described, but by two direct measurements. In a first measurement, the entire outside diameter 20 is illuminated using a source. The lens 1, preferably with no diaphragm, provides a sharp image of the diameter 20 on the matrix sensor 4. In a second measurement, light is injected into the core 21 of the fiber 19. The objective 30, equipped with the diaphragm 28, provides a light spot 27 on the matrix sensor 4.

In a third mode of implementation, the position of the intersection of the reference axis 22 with the optical face 23 may be determined, not by pivoting each connector 16 to be measured, but by a calibration method. The position of the intersection of the reference axis 22 with the optical face 23 of a first connector is determined beforehand, for example according to the first or the second method described, and said position is stored. The device permitting this third method includes a means for centering the reference diameter 20, which is fixed relative to the objective 30. The centering means makes it possible to receive several connectors 16 to be measured and guarantees the reproducibility of the positioning of the reference axis 22. The computer measures the distance between the point 32 and a point stored during the calibration. In this mode of implementation, each connector 16 is measured only once.

According to a variant, the diaphragm 28 may be placed at another point. For example, a pupil may be placed on the entry face of the objective 30.

The device and the method of the invention are not limited to measuring concentricity. They may be used for measuring optical fibers having a preferential radial direction, such as polarization-maintaining fibers or fibers with holes for example. The device of the invention, combined with a means of determining said radial direction, makes it possible to measure the position of the axis of the core 21 of the optical fiber 19 relative to a coordinate system defined by the reference axis 22, said radial direction and the direction of propagation of light in the optical fiber.

The means for observing the light spot 27 is not limited to a matrix sensor 4. An eyepiece system, the object focal plane of which is positioned in the image plane 5, may be equipped with a graticule for determining the position of the light spot 27.

1-12. (canceled)

13. A device for measuring the position, especially the concentricity, of the core (21) of an optical fiber (19) relative to a reference axis (22), comprising a means for determining the position of the intersection of the reference axis (22) with an optical face (23) on the end of the optical fiber (19), a means (17) for injecting light into the core (21) of the optical fiber (19), an objective (30) and a means (4) for observing, in a plane (5) conjugate with the optical face (23), the light emitted by the core (21) of the optical fiber (19), characterized in that the objective (30) has a numerical aperture (sin β) smaller than the numerical aperture (sin α) of the optical fiber to be measured.

14. The device as claimed in claim 13, in which the numerical aperture (sin β) of the objective (30) is less than 0.11, or preferably less than 0.08 or in particular less than 0.06.

15. The device as claimed in claim 13, in which the numerical aperture (sin β) of the objective (30) is greater than 0.01, or preferably greater than 0.02 or in particular greater than 0.03.

16. The device as claimed in claim 13, in which the observation means is a digital camera sensitive to the light of the injection means (17).

17. The device as claimed in claim 13, intended for measuring the concentricity of the core of the fiber of an optical connector, the reference axis (22) of which is defined by an outside diameter (20) of a ferrule (18) of the optical connector, the device comprising a means for pivoting the optical face (23) relative to the outside diameter (20) of the ferrule (18), a means for calculating the position (14) of the center of the optical core (21) for each of the positions of the optical face (23), and a means for calculating the diameter of the circle passing through said positions of the center of the optical core (21).

18. The device as claimed in claim 13, in which the optical axis (31) of the objective (30) is approximately aligned with the reference axis (22) and the numerical aperture (sin β) of the objective (30) is obtained by a diaphragm (28) positioned in the image focal plane (3) of the objective (30).

19. The device as claimed in claim 13, in which the numerical aperture (sin β) of the objective (30) is obtained by a pupil positioned on the transverse entry plane of the objective (30).

20. A method for measuring the concentricity of the core (21) of an optical fiber (19) relative to a reference axis (22), the optical fiber (19) having an optical face (23) at one end, in which method light is injected into the core (21) of the optical fiber (19), the light emitted by the core (21) is observed by means of an objective (30) and the position of the intersection of the reference axis (22) with the optical face (23) is determined, characterized in that the propagation modes that are peripheral to the central axis (31) of the objective (30) are filtered out.

21. The method as claimed in claim 20, using an objective (30) the numerical aperture (sin β) of which is smaller than the numerical aperture (sin α) of the optical fiber (19) to be measured.

22. The method as claimed in claim 20, in which the determination of the position of the intersection of the reference axis (22) with the optical face (23) includes a first step in which the reference axis (22) of the fiber (19) to be measured is positioned relative to the objective (30) and a first position (32a) of the center of the light spot (27a) emitted by the fiber (19) is measured in an image plane (5) of the objective (30) and then, in a second and a third step, the fiber (19) is pivoted in two other angular positions about the reference axis (22), a second position (32b) and a third position (32c) of the center of the emitted light spot are measured and the center of the circle passing through said three positions (32a, 32b, 32c) is calculated.

23. The method as claimed in claim 20, which includes a prior step in which the position of the intersection of the reference axis (22) with the optical face (23) is determined by means of a first optical fiber, said position is stored and then the reference diameter (20) of the optical fiber to be measured is repositioned so that the reference axis (22) of the fiber to be measured is in the identical position to the reference axis (22) of the first fiber.

24. The method as claimed in claim 20, intended for an optical connector (16), the reference axis (22) of which is defined by a reference diameter (20) relative to which an optical face (23) is fixed, in which method the position of the intersection of the reference axis (22) with the optical face (23) is determined by illuminating the diameter (20) and by calculating the position of the center of said diameter (20).

25. The method as claimed in claim 21, in which the determination of the position of the intersection of the reference axis (22) with the optical face (23) includes a first step in which the reference axis (22) of the fiber (19) to be measured is positioned relative to the objective (30) and a first position (32a) of the center of the light spot (27a) emitted by the fiber (19) is measured in an image plane (5) of the objective (30) and then, in a second and a third step, the fiber (19) is pivoted in two other angular positions about the reference axis (22), a second position (32b) and a third position (32c) of the center of the emitted light spot are measured and the center of the circle passing through said three positions (32a, 32b, 32c) is calculated.

26. The method as claimed in claim 21, which includes a prior step in which the position of the intersection of the reference axis (22) with the optical face (23) is determined by means of a first optical fiber, said position is stored and then the reference diameter (20) of the optical fiber to be measured is repositioned so that the reference axis (22) of the fiber to be measured is in the identical position to the reference axis (22) of the first fiber.

27. The method as claimed in claim 21, intended for an optical connector (16), the reference axis (22) of which is defined by a reference diameter (20) relative to which an optical face (23) is fixed, in which method the position of the intersection of the reference axis (22) with the optical face (23) is determined by illuminating the diameter (20) and by calculating the position of the center of said diameter (20).

28. The device as claimed in claim 14, in which the numerical aperture (sin β) of the objective (30) is greater than 0.01, or preferably greater than 0.02 or in particular greater than 0.03.

29. The device as claimed in claim 14, in which the observation means is a digital camera sensitive to the light of the injection means (17).

30. The device as claimed in claim 14, in which the optical axis (31) of the objective (30) is approximately aligned with the reference axis (22) and the numerical aperture (sin β) of the objective (30) is obtained by a diaphragm (28) positioned in the image focal plane (3) of the objective (30).

31. The device as claimed in claim 17, in which the optical axis (31) of the objective (30) is approximately aligned with the reference axis (22) and the numerical aperture (sin β) of the objective (30) is obtained by a diaphragm (28) positioned in the image focal plane (3) of the objective (30).

32. The device as claimed in claim 14, in which the numerical aperture (sin β) of the objective (30) is obtained by a pupil positioned on the transverse entry plane of the objective (30).
